(19) United States
(12) Patent Application Publication
(10) Pub. No.: US 2004/0046897 A1
(43) Pub. Date: Mar. 11, 2004

(54) Receiver and method for controlling receiver

(76) Inventors: Hirohito Kitatora, Osaka-shi (JP); Senju Kobayashi, Yokohama-shi (JP); Yoshihisa Tanaka, Tokyo (JP); Tetsutaro Kohno, Yokohamashi (JP)

Correspondence Address: Pitney Hardin Kipp & Szuch, 685 Third Avenue, New York, NY, 10017-4024, US

(21) Appl. No.: 10/381,455

(22) PCT Filed: Sep. 21, 2001
(86) PCT No.: PCT/JP01/08248

(30) Foreign Application Priority Data
Sep. 26, 2000 (JP) 2000-292302

(51) Int. Cl. H04N 5/445; G06F 3/00

(52) U.S. Cl. 348/731; 348/732; 725/38

(57) ABSTRACT

The receiving device is equipped with two or more receivers or tuners, and the changing of a channel for one receiving device is freely entrusted to users. At the same time, users cannot change a channel for another receiving device in principle, and a party transmitting data such as a program can control it. Additionally, the data received by another receiver can be automatically stored, and the data to control each type of the receiving device itself or advertisement for company can be stored and utilized from time to time.

### FIELD OF THE INVENTION

The present invention relates to a television set, a set-top box, and other receiving devices. Especially, the invention relates to a receiving device that has two or more receivers with different functions.

### BACKGROUND OF THE INVENTION

Conventionally, a receiving device such as a television set or a set-top box had only one receiver. Among VTRs (video tape recorders), there were some that had two receivers or tuners. And, while users view and listen to a program, such VTRs had a function allowing the recording of a program on a different channel. However, the purpose of the two receivers or tuners was to select either one of program signals from the frequencies that were transmitted. Such receivers or tuners had basically the same functions.

### SUMMARY OF THE INVENTION

In a conventional television set, video tape deck, set-top box, etc., despite the existence of two receivers or tuners, all of the receivers or tuners were controlled only through the receiving device. This is to say, it was possible to control whether receiving would be performed by the receiving device or not, and in case that receiving was to be performed, which channel should be selected, etc., only through the receiving device. Therefore, it was impossible to control the receivers from a broadcasting station, etc. as a transmitting party. So, even though the receiving device was equipped with a data storage part, no data could be freely stored by a transmitting party. Also, a transmitting party of a program could not select the programs that were shown on a display or the programs stored in a storing device.

In order to resolve this problem, in the present invention, the receiving device has been equipped with more than two receivers. Users can freely change the channel of one of the receivers, and cannot change a channel of another receivers, in principle. Yet, a party transmitting data, such as a program, can control it. Also, data received from another receiver can be automatically stored, where the data to control each function of receiving device itself and advertisements for companies can be stored and utilized from time to time.

### BRIEF DESCRIPTION OF THE DRAWINGS

FIG. 1 is a functional block diagram showing the receiving device of the present invention.

FIG. 2 is a block diagram showing utilization of the present invention.

FIG. 3 is a functional block diagram showing the receiving system including the present invention.

FIG. 4 is a functional block diagram showing the first receiving part of the receiving device of the present invention.

FIG. 5 is a diagram showing one example of the concepts for changing a channel with the present invention.

FIG. 6 is a diagram showing one example of the data that the second receivers receives in the present invention.

FIG. 7 is a functional block diagram showing the receiving system of the present invention.

FIG. 8 is a functional block diagram showing other examples of the present invention.

FIG. 9 is a functional block diagram showing the second receiver as another example of the present invention.

FIG. 10 is a conceptional diagram showing situations for utilization as another example of the present invention.

FIG. 11 is a flow chart to show the process of the resent invention.

FIG. 12 is the other flow chart to indicate the process of the present invention.

FIG. 13 is a further flow chart to demonstrate the process of the present invention.

### DETAILED DESCRIPTION OF THE PREFERRED EMBODIMENT

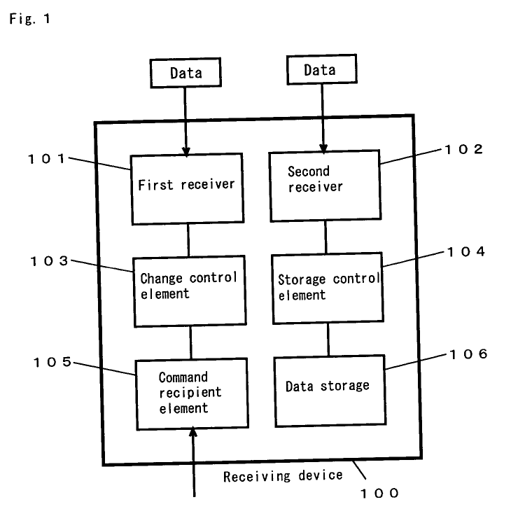

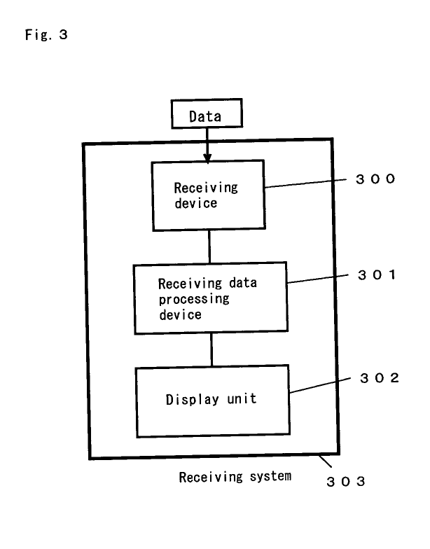

FIG. 3 is a schematic of the system, including the receiving device 300 of the present invention. The data for a program, etc. is received by the receiving device 300 of the present invention, the data received is partially stored or transmitted to the receiving data-processing device 301, and processed into a signal for presentation on a display, or processed into a voice signal. And the data is transmitted to the display unit 302, etc., where it can be displayed to be viewed and listened to by users. The present invention relates to the receiving device 300 in the receiving system 303. More specifically, the present invention relates to a receiving device shown in the functional block of FIG. 1.

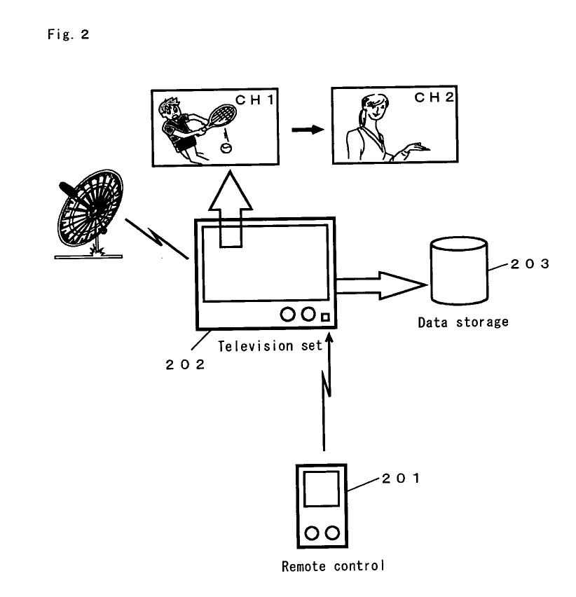

As shown in FIG. 1, the receiving device 100 of the present invention includes a first receiver or tuner 101, a second receiver 102, a command recipient element 105, a change control element 103, a storage control element 104, and a data storage 106. The first receiver 101 receives a primary data, and the second receiver 102 receives a secondary data. The primary data could be, for instance, a movie, and the secondary data could be, for example, an advertisement for an automobile owned by a leading character appearing in the movie. The data storage 106 stores the data. A hard disk, RAM, cache memory, ROM, DVD, or FDD will do for the data storage 106. The command recipient element 105 receives a command to change a channel, which the first receiver 101 receives. The storage control element 104 stores the data received by the second receiver 102 in the data storage 106. Such functions operate as shown in FIG. 2.

As shown in FIG. 2, hypothetically, the first receiver 101 receives a program on the channel 1. When users desire to change to the channel 2 on the television 202, the command to change the channel is given to the command recipient element 105 by a remote control unit, etc. The command recipient element 105 is a part to receive a signal of the remote control 201, etc., and in case that the remote control 201 is an infrared remote control, the command recipient part is an infrared light-receiving part and a signal-processing means incidental thereon, etc. When the command recipient element 105 receives a command to change a channel to the channel 2, the command to change is passed over to the change control part, and control to change the channel at the first receiving part is performed. As a result, a program of the channel 2 is also displayed on the display unit. In such case, the data received by the second receiver 102 is stored in the data storage 203.

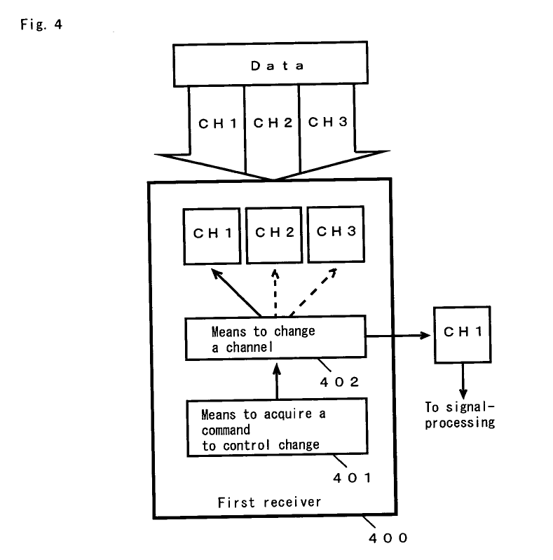

A situation where a channel at the first receiver 107 is changed by the change control element is shown in FIG. 4. For example, when the first receiver 400 is able to receive the data of the channels 1 to 3, the channel received by the receiving device can only be one of them. Therefore, the first receiver 400 must select one from among them. For this selection, the first receiver 400 has the means to acquire a command to control change 401, and the means to change a channel 402. The means to acquire a command to control change 401 acquires a command to change from the change control part, and the means to change a channel 402 changes a channel in accordance with such command to change.

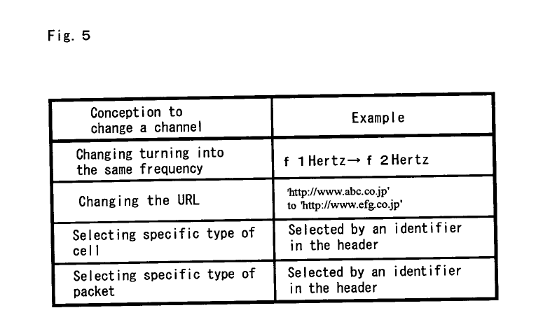

Changing a channel here means tuning into the carrier wave carrying an analog terrestrial signal, which is utilized for conventionally existing television broadcasting as shown in FIG. 5. For instance, this means that tuning into the same frequency is changed from f1 Hertz to f2 Hertz. In addition, this also includes changing the URL of a broadcasting station in the case of the internet broadcasting, for example, from ‘http://www.abc.co.jp’ to ‘http://www.efg.co.jp.’ And in case that multiple channels are multiplexed and transmitted in the TDMA method by using packet communication or ATM communication, it involves selecting the packet or cell based on the management information added to the header, etc. For example, a specific type of packet or cell is selected by an identifier, which is included in the header, etc.

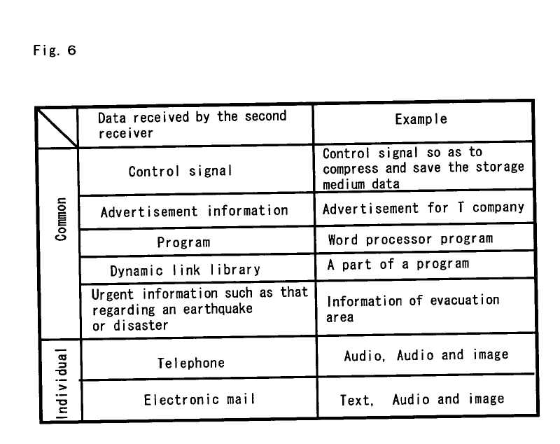

On the other hand, the second receiver receives the secondary data, which is stored in the data storage part by the storage control part. As shown in FIG. 6, the data received by the second receiver includes a control signal so as to control the functions for the receiving device, the receiving data-processing device, display unit, and the devices attached to this system, for example, a control signal so as to compress and save the storage medium data. And it includes advertisement information so as to have the users view and listen thereto by showing such information on the display unit as well as a program, for example, an advertisement for an automobile manufactured by T company. It further includes a program so as to cause the receiving device, the receiving data-processing device, the display unit, etc., to execute specific processes, for example, a program to perform the word processor function. And it includes the item which constitutes a part of a program, such as dynamic link library and the like. It further includes a signal in order to transmit urgent information such as that regarding earthquake or disaster, for instance, information about evacuation areas at the time of a disaster.

Such data is commonly transmitted from a transmitting station to the entire receiving system under the control thereof by broadcasting. Additionally, the data received at the second receiver may be an individual signal such as a telephone signals or electronic mail exchanged among the receiving systems. The signal received at the second receiver is stored in the storage, which makes it available to access and use any time thereafter. Additionally it creates an effect that makes it possible to use such signal as many times as possible, not only once, as long as it is stored.

For instance, once an urgent signal is stored, such as one regarding earthquakes or disasters, even if a broadcasting function such as a broadcasting station is suspended, it is possible to access such signal, and it is convenient for information that is necessary to confirm several times, such as guidance to evacuation areas, or information about the range of the disaster. Additionally, advertisement information for a company will not be changed every time it is shown on the display, and once it is stored, it is possible to access it from the storage device any time thereafter, and show it on the display conveniently.

Causing this type of information to be included and transmitted in the data received by the first receiver, it may be possible to believe that the information is received at one receiving device, is signal-processed internally, and is processed. However, a program, etc. is organized at a broadcasting station once and a reconfigured signal is transmitted, in order to pass the management signal, advertisement, or urgent information to the broadcasting station, and make a reconfiguration thereof. This is inconvenient in that it takes a large amount of time and effort.

Furthermore, control of the first receiver is basically entrusted to users. Therefore, in order to cause anyone to view and listen to content which must be to viewed and listened to, such as urgent information, it would be more convenient to separate the receiving device into more than two elements, and control them separately from the device receiving the data, such as general programs. It is convenient to use a configuration such that users cannot exercise a control such as changing the channel of the second receiver, etc., for example.

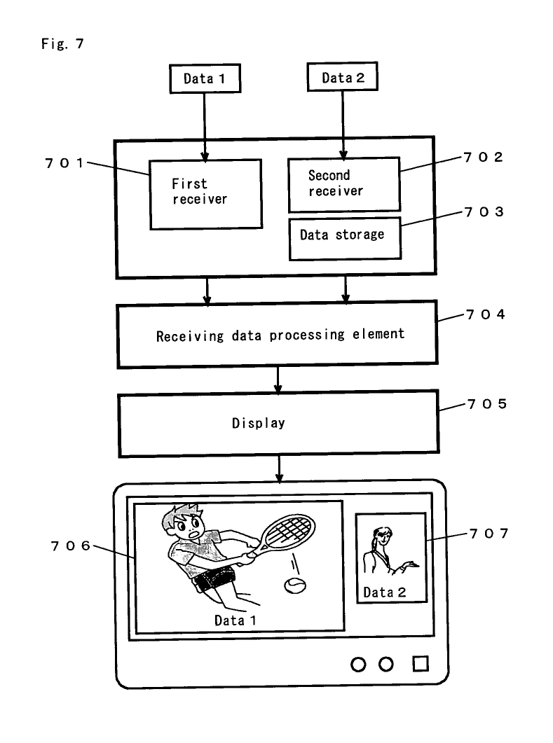

FIG. 7 shows a case where the data received by the second receiver 702 is an advertisement for a company. The data 1 (706) received by the first receiver 701 is shown as a program on a large part of the display, for instance, in an area comprising 70-90% thereof, via the receiving data-processing element 704 and the display 705, and users view and listen thereto. At the same time, the data 2 (707) received by the second receiver 702 is stored in the data storage 703, is transmitted to the receiving data-processing element 704, and is shown on the remaining part of the area not occupied by the data 1 (706), via the display 705.

Because such data is an advertisement, it is shown on the display to the extent that it does not disturb the viewing and listening to a program by users. Regarding this advertisement for a company, the data is received by the second receiver 702, and may be displayed simultaneously therewith. Alternatively, after the data is stored in the data storage 703 once, the data may be displayed. Therefore, even when the second receiver 702 does not receive the advertisement, the data can be viewed on the display by extracting the data from the data storage 703.

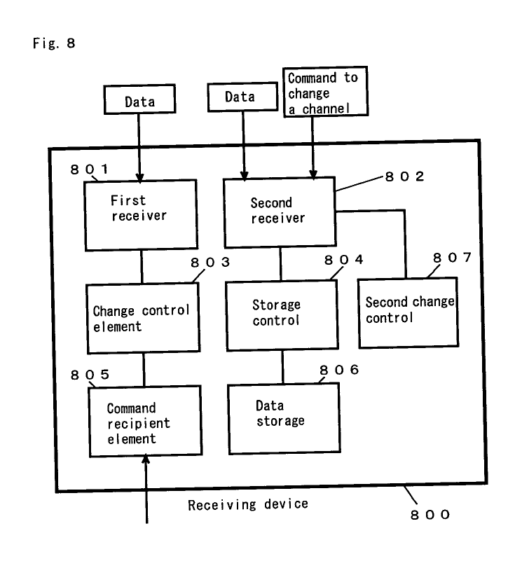

Next, the data reception by the secondary data receiving part and a command to change a channel is explained. As shown in FIG. 8, the receiving device includes a first receiver 801, a second receiver 802, a change control element 803, a storage control 804, a command recipient element 805, a data storage 806, and a second change control 807. The second receiver 802 receives data and a command to change a channel. A command to change a channel relates to the second receiver 802. The basic functions of the first receiver 801, the change control element 803, the command recipient element 805, the storage control 804, and the data storage 806 are the same as the functions of the receiving device, which has been explained hereinabove.

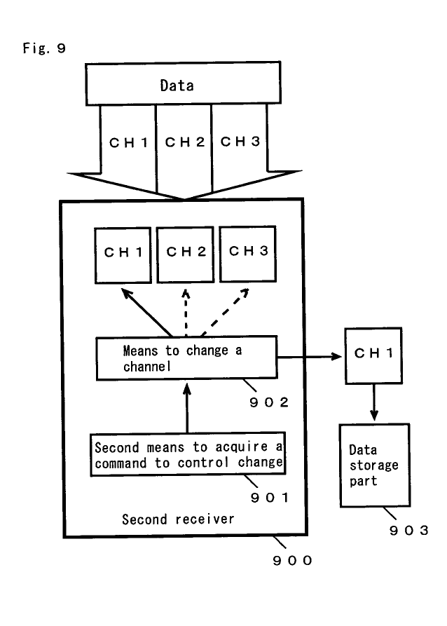

The second receiver 802 receives data and a command to change a channel, and the second change control element 807 controls the changing of a channel of the second receiver 802 based on the command to change a channel received at the second receiver 802. The second receiver 802 receives a signal from the second change control element 807, and performs the changing of a channel by configuration shown in FIG. 9. As shown in FIG. 9, the second receiver 900 is composed of the second means to acquire a command to control change 901 from the second change control part and a means to change a channel 902 based on a command to change from the second means to acquire a command to control change 901. In case that channel 1 is selected by the means to change a channel 902, the data of channel 1 is stored in the data storage part 903. When a channel is changed, data concerning the channel which has been changed is stored in the data storage part 903.

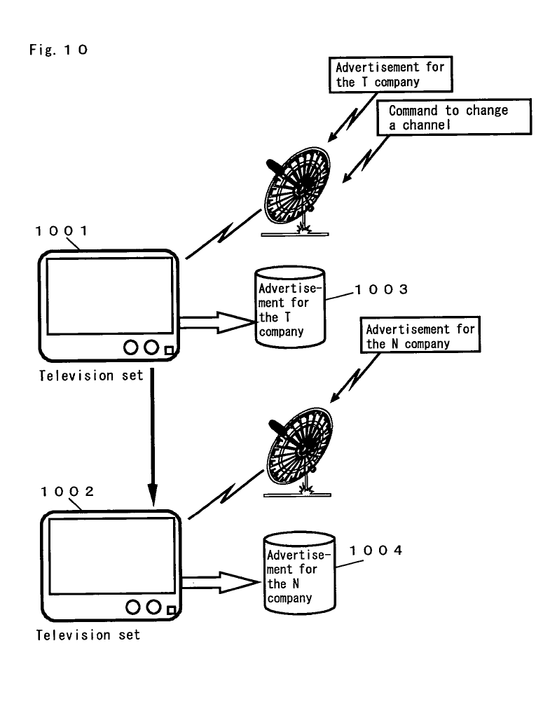

This situation is shown in FIG. 10. In case that the receiving system including the receiving device is a television set, the second receiver of the receiving device for the television set 1001 initially receives the data of the advertisement for the T company, and stores the data at the data storage 1003. However, receiving a command to change a channel at the second receiver of the receiving device for the television 1002, a channel will be changed to the channel of the advertisement for the N company, such data will be received, and be stored in the data storage 1004. In the meantime, a program not related to the advertisement may be displayed on the television set. Alternatively, while the advertisement for the T company is initially displayed, and with a command to change a channel, a process for the advertisement of the N company to be displayed may be made. In addition, the form of the implementation of this invention indicated above shows an example of this invention, and is not given with the purpose of restricting the scope of rights for this invention. The scope of rights for this invention is not limited by such examples, and includes all forms of implementation that are applicable.

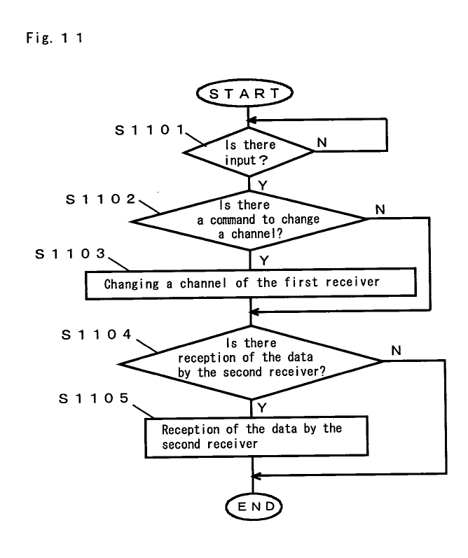

Next, the control method for the receiving device is explained. As shown in FIG. 11, firstly, an input for receiving is waited for (Step S1101), and after the input is made, it is determined whether a command to change a channel is made or not (Step S1102). After the command to change a channel is made, a channel of the first receiver is changed (Step S1103). Secondly, it is determined whether there is reception of the data by the second receiver (Step S 1104), and in case that there is reception of the data, such data is received (Step S 1105), and the processing is completed.

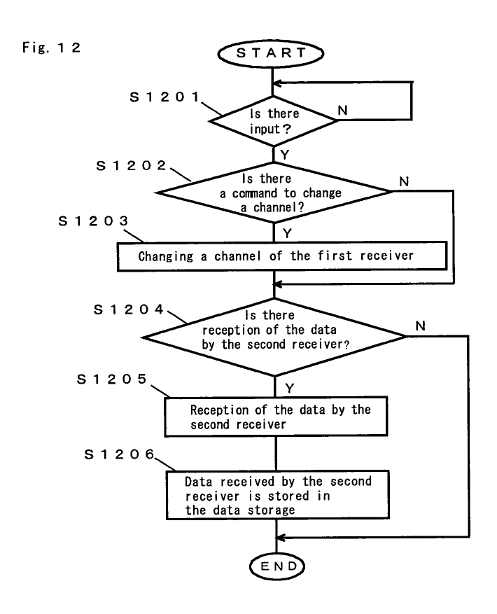

Also, as shown in FIG. 12, the data received by the second receiver may always be stored in the data storage. The process indicated in FIG. 12 shows that an input for receiving is waited for (Step S 1201), and after the input is made, it is determined whether a command to change a channel is made or not (Step S1202). After the command to change a channel is made, a channel of the first receiver is changed (Step S1203). Secondly, it is determined whether data of the second receiving part is received (Step S 1204). In case that there is reception of the data, such data is received (Step S 1205), and the received data is stored at the data storage (Step S 1206), and the processing is completed.

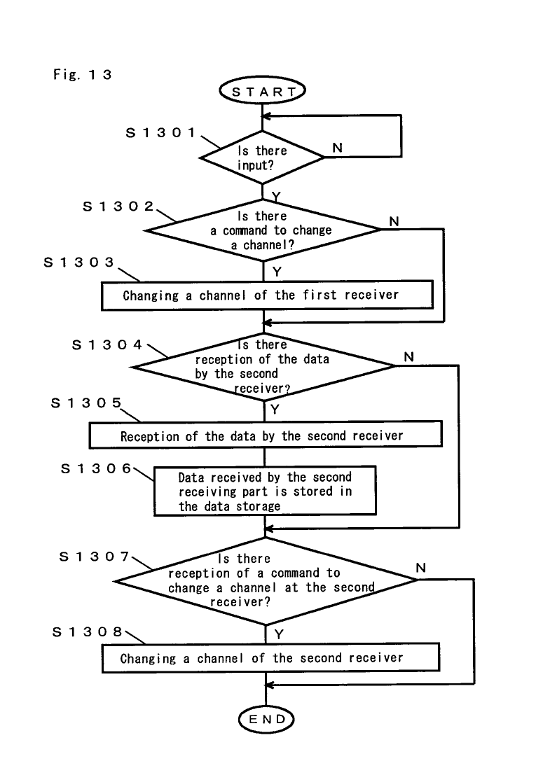

FIG. 13 explains a case where a signal to change a channel is received by the second receiver is received at the second receiver. An input for receiving is waited for (Step S 1301), and after the input is made, it is determined whether a command to change a channel is made or not (Step S1302). After the command to change a channel is made, a channel of the first receiver is changed (Step S1303). Secondly, it is determined whether there is reception of the data of the second receiver (Step S 1304), and in case that there is reception of the data, such data is received (Step S 1305) and the received data is stored at the data storage (Step S 1306). Furthermore, it is determined whether there is reception of a command to change a channel at the second receiver (Step S 1307), and in case that there is reception, a channel of the second receiver is changed (Step S 1308), and the processing is completed.

Such processes are not necessarily performed at the receiving device or receiving system, and may be performed at peripheral equipment incidental thereon. In addition, it would be convenient to allow the program to execute the processes shown in FIG. 11 through FIG. 13 to be the recording medium, which is recorded to be readable by computer. The definition of being readable by computer includes being readable by the receiving system or the receiving device.

The present invention can receive a signal to control the receiving device itself or an advertisement for a company, in addition to programs for viewing and listening to. Therefore, it is possible for a transmitting party of the program to control the receiving device and the receiving system itself. For instance, despite the presence of a program that is viewed and listened to, it is possible to show the advertisement for a company on the display.

What is claimed is:

1. A receiving device equipped with:
a first receiver receiving data;
a second receiver receiving data and a first command for changing a channel;
a data storage storing data;
a command recipient element receiving a second command to change a channel;
a first change control element changing a channel received at said first receiver when a second command to change a channel is received by said command recipient element;
a second change control element changing a channel received at said second receiver when a first command to change a channel is received at said second receiver; and
a storage control element storing the data received by said second receiver in said data storage.

2. A method for controlling a receiving device equipped with a first receiver receiving data, a second receiver receiving data, and a data storage storing data, comprising:
a step to receive a second command to change a channel;
a step to change the channel of the first receiver due to a second command to change a channel;
a step to receive data at the first receiver based on the channel changed at previous step;
a step to receive a first command to change a channel;
a step to change the channel received at the second receiver due to a first command to change a channel;
a step to receive data at the second receiver based on the channel changed at previous step; and
a step to store data received by the second receiver in the data storage.

3. A program, in order to control a receiving device equipped with a first receiver receiving data, a second receiver receiving data, and a data storage storing data, to make a computer to execute:
a process to receive a second command to change a channel;
a process to change the channel of the first receiver due to a second command to change a channel;
a process to receive data at the first receiver base on the channel changed at previous process;
a process to receive a first command to change a channel;
a process to change the channel received at the second receiver due to a first command to change a channel;
a process to receive data at the second receiver based on the channel changed at previous step; and
a step to store data received by the second receiver in the data storage.

4. A receiving device equipped with:
a first receiver receiving data;
a second receiver receiving data and a first command to change a channel;
a data storage storing data;
a command recipient element receiving a second command to change a channel from an audience;
a first change control element changing a channel received at said first receiver when a second command to change a channel is received by said command recipient element;
a second change control element changing a channel received at said second receiver when a first command to change a channel is received by said second receiver; and
a storage control element storing data received by said second receiver in said data storage;
characterized in that an audience cannot change a channel received at said second receiver.

5. A method for controlling a receiving device equipped with a first receiver receiving data, a second receiver receiving data, and a data storage storing data and characterized in that an audience cannot change a channel received at the second receiver, comprising:
a step to receive a second command to change a channel from an audience;
a step to change a channel at the first receiver due to a second command to change a channel;
a step to receive data at the first receiver based on the channel changed at previous step;
a step to receive a second command to change a channel from other than an audience;
a step to change a channel received at the second receiver due to a first command change a channel;
a step to receive data at the second receiver based on the channel changed at previous step; and
a step to store data received by the second receiver in the data storage.

6. A program, in order to control a receiving device, equipped with a first receiver receiving data, a second receiver receiving data, and a data storage storing data, such that a channel received at the second receiver cannot be changed by an audience, to make a computer execute:
a process to receive a second command to change a channel from an audience;
a process to change a channel at the first receiver due to a second command to change a channel;
a process to receive data at the first receiver based on the channel changed at previous process;
a process to receive a second command to change a channel from other than an audience;
a process to change a channel received at the second receiver due to a first command change a channel;
a process to receive data at the second receiver based on the channel changed at previous process; and
a process to store data received by the second receiver in the data storage.
